(19) United States
(12) Patent Application Publication
(10) Pub. No.: US 2008/0297341 A1
(43) Pub. Date: Dec. 4, 2008

(54) Real-time passenger identification, passenger onboard inventory, location and safety monitoring system

(76) Inventor: James B. McClanahan, Huntington Beach, CA (US)

Correspondence Address: Galasso & Associates, LP, P.O. Box 26503, Austin, TX, 78755-0503, US

(21) Appl. No.: 11/518,825

(22) Filed: Sep. 11, 2006

(51) Int. Cl. G08B 1/08; H04Q 5/22; G08B 23/00

(52) U.S. Cl. 340/539.13; 340/10.42; 340/573.6

(57) ABSTRACT

An automated passenger identification, passenger onboard counter and passenger inventory monitoring systems for maintaining a roster of passengers onboard a conveyance such as a school bus, train, or ship. The system comprises one or more transponders, each transponder embedded within identification means and each identification means assigned to and carried by one passenger. Each transponder has a unique identity code such that when a passenger is assigned an identity means there is created one to one relationship between the unique identity codes and passenger. The transponder in the identification means has an antenna embedded in the card for reception of an identity request via a transmitted radio frequency signal. In response to the identity query signal, the transponder transmits a response radio signal containing the unique identity code of the transponder thereby identifying the passenger. Transceivers for communicating with the identity means transponder being mounted at access points to and possibly is various locations around or within the conveyance.

### FIELD OF THE DISCLOSURE

The disclosures made herein relate generally to radio frequency, transponders and transceivers for reading such transponders and tags, and more particularly to radio frequency transponders embedded into passenger carried identity cards, electronic room keys or secured to wrist bands, together with a plurality of radio frequency transceivers adapted to read identifying information from the identity cards, keys and wrist bands wirelessly and over a distance of separation and provide such real-time information to a real-time passenger counting, identification and passenger roster or inventory monitoring system. This system is herein referred to as “Omni”.

### BACKGROUND

Passenger identification, counting, and maintaining a roster of passengers onboard a conveyance is an important and necessary task that is too often performed manually, with the need for the driver, operator or crew to manually keep a running count of passengers onboard, or in the case of a school bus, to call roll and check passenger names off on a passenger roster.

For a specific example, lets look at the cruise ship industry. For many people booking a vacation voyage to warm and sunny port of call on a cruise ship is a long anticipated and well appreciated break from the work pressures of everyday life.

For a ship operator and crew, it is supremely important to know that your passengers are all onboard for complying with safety, security requirements as well as reducing the impact of a disaster. Emergency services are greatly aided by accurate details about who is aboard if incidents occur. On a cruise ship, determining the whereabouts of a passenger can be very difficult. The sheer size of the cruise ship can make the hunt for a passenger very time consuming and cruise ships are capable of carrying hundreds of passengers, further impeding the search for a particular passenger among the multitudes onboard. Furthermore, passengers may be disembarking the ship for shore excursions when the ship is in a port of call. As a result, determining one passenger's whereabouts becomes even harder, especially if the passenger is off the ship for the entire day. Other circumstances can arise, such as the need to find a potentially missing passenger, one who is believed to have been onboard the ship at some point but is no where to be found now. Did the passenger actually return from shore? Has the passenger taken ill, or had an accident on board? Where was the last time and place he was seen onboard the ship? When a passenger is unaccounted for, concerned families have a ceaseless array of questions and concerns, and there are the government requirements for ‘souls on board’ record keeping and passenger tracking.

For another example, let us consider another conveyance means such as a school bus. For example when a school bus is used to transport students on a field trip it is usually necessary for the operator or a teacher to keep track of who has returned to the bus and who is absent, say after visiting a museum. The count must be performed manually, and often a roll call is used to verify who is on board and that all students have returned.

As can be understood, conventional methods of accounting for and identifying passengers on a conveyance have many limitations. Manual methods are themselves prone to errors and do not provide an accurate real-time inventory of who is on board and who is missing. This is a problem for commercial vessels such as tanker and fishing vessels, as well as cruise line, busses, school busses, trains as well as other means of public conveyance.

Returning now to the cruise or commercial ship example, it is rare that people fall overboard from a ship and when it happens the outcome is often tragic. The ship captain and operators may not be aware that a passenger or crew member has fallen overboard until some time after it occurs, or may never really know for sure what happened to the missing passenger particularly if no one observed the incident.

On such as ship what is needed is a system that keeps a running real-time inventory of passengers on board, a system that can detect when a passenger falls over a deck railing and can immediately notify the bridge and crew of the incident. Just to define the position where someone fell overboard can save a life and speed up rescue efforts. Of course it would be nice to have something like an alarm to immediately notify the officer on the bridge to stop the engines and immediately trigger a rescue effort.

In the case of a school bus, a system as described above can be advantageously applied to keep a running count of students returning to the bus, say on a field trip, and eliminates the need to keep a manual count or to cal roll to identify who is onboard and who is still missing.

Therefore, a passenger identification and inventory system that can identify passengers as they leave from or return to a conveyance, a system that can monitor passenger presence and in its for expansive forms can track the location of passengers and crew on board a ship in real time, a system that works wirelessly using radio wave signals and without a human assistance, a system which when used on a ship can detect when a passenger leaps or accidentally falls overboard while at sea, a system that can be embedded into electronic ship passenger cabin room key cards, onboard passenger identification cards or wrist bands worn on passenger's wrist, a system that can notify a conveyance operator, driver, captain or crew in real time the current onboard passenger tally and passenger roster, such a passenger identification and inventory system would be useful and novel.

### SUMMARY OF THE DISCLOSURE

Accordingly, embodiments of the inventive disclosures made herein comprise various embodiments of a real-time conveyance passenger identification, on-board inventory and passenger safety monitoring system.

In embodiments of the inventive disclosures made herein, a real-time passenger on-board inventory and passenger safety monitoring system comprises one or more transponders, each transponder embedded within an identification means which may comprise an identification card, electronic key, wearable wrist band, other suitable means. Each identification means assigned to and carried by one passenger. Each transponder has a unique identity code. When a passenger is assigned an identity means there is created a one to one relationship between unique identity code and the passenger. The transponder identification means has an antenna embedded in the identification means for reception of an identity request via a transmitted radio frequency signal from a transceiver. In response to the identity query signal, the transponder transmits a response radio signal containing the unique identity code of the transponder thereby identifying the passenger. Transceivers for communicating with the identity means transponders are mounted in one or more various locations about the means of conveyance. In the case of a bust this would be near the passenger entrance and exit doors. Each transceiver is adapted to transmit a query radio frequency signal to any and all identification card transponders located within a limited range of the transceiver. Each transceiver is adapted to receive responses from one or more identification card transponders that may be within range. In the case of a cruise ship transceivers for communicating with the identity means transponders are advantageously mounted in various locations around the ship so as to aid in identifying the location of passenger onboard.

In at least one embodiment, a real-time bus passenger on-board inventory, and passenger safety monitoring system comprises one or more transponders. Each secured within a passenger identification means and each identification means is assigned to and carried by one passenger. Each transponder has a unique identity code wherein each passenger is associated with the unique identity code. The passenger identification means transponder is responsive to a received query request transmitted over a radio frequency signal and is configured to transmit a response radio signal comprising the passenger identity code in response to the received query signal. One or more of transceivers adapted to transmit a query radio frequency signal to identification means transponders within a limited range and the transceiver adapted to receive responses from a plurality of identification means transponders. The transceivers are secured to the bus near passenger entrance and exit doors so as to detect and identify passengers boarding and leaving the bus. A passenger counter and passenger inventory database provides a real-time inventory of passengers currently onboard, as well as who is missing from the group. One or more display stations are in communication with the passenger inventory database such that the display stations display the passenger onboard tally.

In another embodiment the passenger identification adapted to a ship, on-board inventory and passenger safety monitoring system includes an identification means transponder location means which is adapted to determine the transponder location (i.e. passenger identification card, electronic room key card, or wrist band location) according to the known locations of the one or more transceivers receiving the response radio signal from the transponder on the identification card. A passenger on ship inventory database is updated with the real-time identity codes and locations from the transponder location means as they are received. Continually updated with this information the database provides real-time inventory of passengers currently onboard, last detected location for each passenger and time detected by accumulating real-time identity codes and locations from the transponder location means. One or more display stations are in communication with the passenger on-ship inventory database, the display stations providing functionality to display the current real-time passenger on board inventory and last detected location and time for each passenger.

In at least one embodiment the passenger identification, on-board inventory and passenger safety monitoring system is installed on a ship, the transponders are located on the gangway between shore and ship, the transponders being capable of identifying passenger direction to ship or to shore by the direction of passenger travel along the gangway and communicating this information to the system wherein the passenger on board inventory is updated accordingly.

In another and at least one embodiment, the passenger identification, on-board inventory and passenger safety monitoring system is installed on a ship, the transceivers are secured to the ship deck railings in spaced positions along railings and the boarding area of the ship is provided with transceivers to identify and log passengers and crew leaving and boarding the ship, the inventory system monitoring passengers boarding or leaving the ship and correcting the on board passenger inventory accordingly. The transceivers on the deck railings are configured to detect a passenger moving beyond the railing over the ship and to report the passenger as overboard to the ship inventory means. The ship inventory means is configured to sound an alarm or alarms to notify the bridge, officers and crew of a man overboard condition so that rescue efforts can be immediately mounted.

In another and at least one embodiment, the passenger identification, on-board inventory and passenger safety monitoring system is installed on a ship, the identification means carried or worn by the passenger further comprises a GPS tracking and transmitter device, the passenger identification means having a wrist band adapted to be securely worn on the wrist of a passenger wherein if a passenger falls overboard the identification means transmits the passenger's GPS position from an embedded beacon transmitter thereby permitting the passenger to be tracked and located for rescue.

In at least one embodiment of the passenger identification, on-board inventory and passenger safety monitoring system as applied to any conveyance, the transponders have an active radio frequency identification device (RFID) chip for constantly broadcasting the unique identity code. The active transponder having an active RFID chip embedded into the identification means, the active RFID chip configured to repeatedly transmit the unique identification code for reception by any transceiver of the present invention that may be in range. A battery electrically is connected to the RFID chip to provide electrical power to the chip, the battery embedded into the identification card. An antenna is connected to the RFID chip and adapted for transmitting the radio signal containing the unique identification code from the RFID chip. The antenna is also embedded in the identification card.

In at least one embodiment of the passenger identification, on-board inventory, last location, and passenger safety monitoring system as applied to any conveyance, the transponders utilize an non-powered passive RFID chip wherein the transponder have a passive RFID chip embedded into the identification means. The RFID chip is adapted so that upon receiving a radio frequency signal query request the RFID chip responds with a radio frequency signal having the unique identification code of the chip. An antenna is electrically connected to the RFID chip and is adapted for receiving and transmitting the radio signals. The antenna, like the RFID chip, is embedded into the identification means, which may comprise an identification card, electronic room key, or wrist band, among other devices.

In at least one embodiment of the passenger identification, on-board inventory and passenger safety monitoring system as applied to a ship, the transceivers are concealed in interior ship designs, fixtures and furniture in selected portions of the ship wherein passengers can be located within selected portions of the ship interior.

In at least one embodiment of the passenger identification, on-board inventory and passenger safety monitoring system as applied to a cruise ship, additional transceivers are positioned at reception desks in the front office, restaurant entrances, shore excursion and concierge desks, and wherein the transceiver detects the passenger identification means unique identification number as the passenger approaches; and wherein display stations are located at said reception desks to identify passengers by name as they approach as an aid to ship staff in greeting passengers by name and as an aid to capturing on board purchases against passenger accounts

It is an objective of the inventive disclosure made herein to provide a passenger identification, on-board inventory and passenger safety monitoring system which has transponder components embedded into passenger wearable identification means.

It is an objective of the inventive disclosure made herein to provide a passenger identification, on-board inventory and passenger safety monitoring system which provides a wireless radio frequency location identification system and on board passenger inventory roster that operates automatically, improves passenger safety, eliminates manual counting and roll calls to determine passenger onboard and passengers missing and does not inconvenience the passengers.

It is an objective of the inventive disclosure made herein to provide a passenger identification, on-board inventory and passenger safety monitoring system in which certain embodiments intended for use on a ship have transceivers so located around ship deck railings as to detect the occurrence of a passenger falling overboard, and report the occurrence to the bridge and crew so that a rescue can be immediately mounted.

It is an objective of the inventive disclosure made herein to provide a passenger identification, on-board inventory and passenger safety monitoring system in which certain embodiments intended for use on a ship have a GPS tracking and transmitter device embedded within the identification means, wherein if a passenger falls overboard the ship the identification means transmits the passenger's GPS position permitting the passenger to be tracked and located for rescue.

It is another objective of the inventive disclosure made herein to provide a passenger identification, on-board inventory and passenger safety monitoring system that can include transceivers concealed in interior ship designs, fixtures and furniture in selected portions of the ship enabling the system to locate individual passengers in the selected locations.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 presents a perspective view of one embodiment of a display or monitoring station in accordance with the inventive disclosures herein.

FIG. 2 presents a perspective view of man overboard and location detection transceivers mounted to a ship deck railing in accordance with one embodiment of the inventive disclosures herein.

FIG. 3 presents a perspective view of a passenger electronic room key or other identification card having a transponder embedded within in accordance with one embodiment of the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

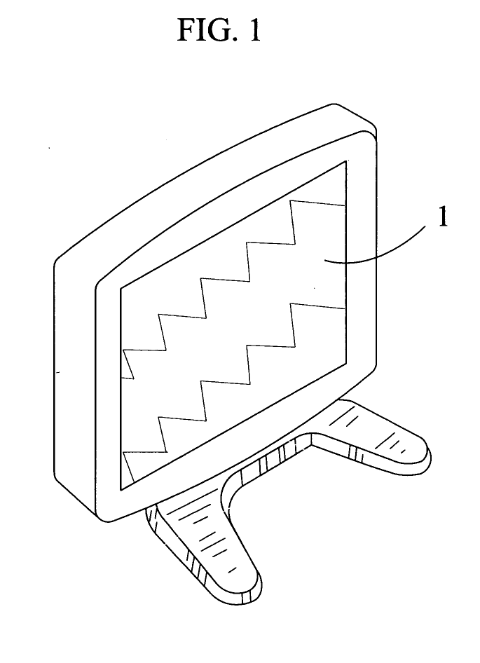

FIG. 1 depicts a perspective view of one embodiment of a display or monitoring station of a real-time passenger on-board inventory and passenger safety monitoring system in accordance with the inventive disclosures herein. Display and monitoring station 1 is in communication with the passenger onboard inventory database of the present inventive disclosures. The display station is adapted to display a variety of real-time reports including a roster of passengers currently detected as on board and in certain embodiments display the passenger last location and time of detection. Other real-time displays include display of passenger names approaching or passing by one or more selected transceiver, particularly when the display station is in use as a passenger name identification system at a conveyance boarding location. In certain embodiments the monitor utilizes a touch sensitive screen, in which case a operator may enter commands and display selections by finger touch on the screen. In another embodiment better suited for data entry, for example at display stations where identification cards or wrist bands are assigned to passengers, the display utilizes a standard PC keyboard for menu and screen selections and for data input.

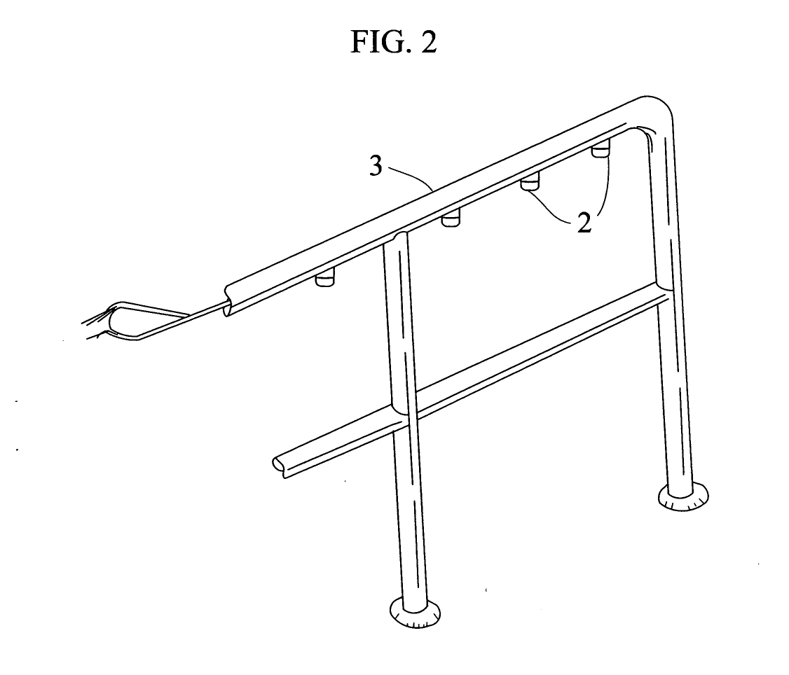

FIG. 2 depicts a perspective view of man overboard and location detection transceivers mounted to a ship deck railing in accordance with one embodiment of the inventive disclosures herein. Transceivers 2 are mounted in a spaced fashion to all ship deck railings where a passenger might possibly fall overboard. The transceivers on the deck railings are configured to detect a passenger moving beyond the railing and report the passenger as overboard to the real-time ship passenger on-board inventory, last location, and passenger safety monitoring system. The system configured to sound an alarm to notify the bridge, officers and crew of a man overboard condition so that a rescue can be mounted.

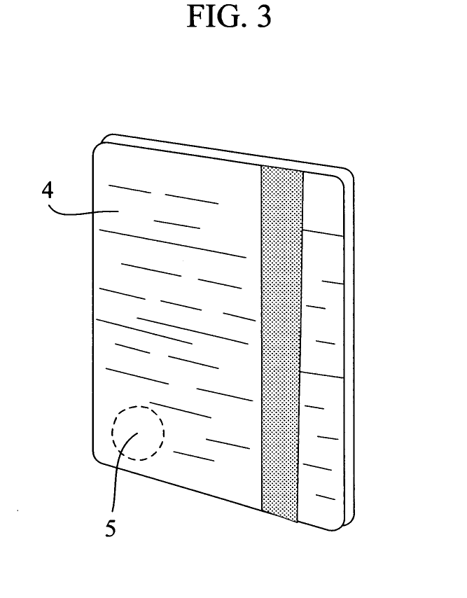

FIG. 3 depicts a perspective view of a passenger electronic room key or other identification card having a transponder embedded within in accordance with one embodiment of the inventive disclosures herein. Passenger identification card or electronic room key card 4 has an embedded transponder 5 in accordance with the inventive disclosures herein. Each card is assigned to and carried by one passenger and each transponder having a unique identity code different from the identification codes of other identification cards, whereby the identification code enables the real-time ship passenger on-board inventory, last location, and passenger safety monitoring system to identify the named passenger by the identification code transmitted by the transponder.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, electrical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A real-time ship passenger on-board inventory and passenger safety monitoring system comprising:
one or more transponders, each secured within an identification means, each identification means assigned to and carried by one passenger, each transponder having a unique identity code wherein each passenger is associated with a unique identify code, the transponder responsive to a received query request transmitted over a radio frequency signal, the transponder adapted to transmit a response radio signal comprising the identity code in response to the received query signal;
a plurality of transceivers adapted to transmit a query radio frequency signal to identification means transponders within a limited range, the transceiver adapted to receive responses from a plurality of identification card transponders;
an identification means transponder location means adapted to determine the transponder location by location of the one or more transceivers receiving the response radio signal, the transponder location means outputting the unique identify code and location in real-time;
a passenger on ship inventory database adapted to provide real-time inventory of passengers currently onboard, last detected location and time detected by accumulating real-time identity codes and locations from the transponder location means; and
one or more display stations in communication with the passenger on-ship inventory database, the display stations adapted to display the passenger inventory and last detected location and time.

2. The real-time ship passenger on-board inventory and passenger safety monitoring system of claim 1, wherein the transponders are located on the gangway, the transponders capable of identifying passenger direction to ship or to shore, by the direction of passenger movement along the gangway.

3. The real-time ship passenger on-board inventory and passenger safety monitoring system of claim 2, wherein transceivers are secured to the ship in spaced positions along deck railings, wherein the boarding area of the ship is provided with transceivers to log passengers and crew leaving and boarding the ship, the inventory system monitoring passengers boarding or leaving the ship and correcting the on board passenger inventory accordingly, the transceivers on the deck railings configured to detect a passenger moving beyond the railing and report the passenger as overboard to the ship inventory means, the ship inventory means sounding an alarm to notify the bridge, officers and crew of a man overboard condition.

4. The real-time ship passenger on-board inventory and passenger safety monitoring system of claim 3, wherein the identification means further comprises a GPS tracking and transmitter device, the identification means having a wrist band adapted to be worn on the wrist of a passenger, wherein if a passenger falls overboard the identification means transmits the passenger's GPS position permitting the passenger to be located for rescue.

5. The real-time ship passenger on-board inventory and passenger safety monitoring system of claim 4, wherein the ship comprises commercial vessel.

6. The real-time ship passenger on-board inventory and passenger safety monitoring system of claim 3, wherein the transponders comprises an active RFID chip for constantly broadcasting the unique identity code, the transponder comprising:
an active RFID chip embedded into the identification means, the active RFID chip configured to repeatedly transmit the unique identification code;
a battery electrically connected to the RFID chip to provide electrical power to the active RFID chip, the battery embedded into the identification means; and
an antenna connected to the RFID chip for transmitting the radio signal containing the unique identification code from the RFID chip, the antenna embedded in the identification means.

7. The real-time ship passenger on-board inventory and passenger safety monitoring system of claim 3, wherein the transponders comprises a passive RFID chip, the transponder comprising:
a passive RFID chip embedded into the identification means, the RFID chip adapted so that upon receiving a radio frequency signal query request the RFID chip responds with a radio frequency signal having the unique identification code; and
an antenna connected to the RFID chip for receiving and transmitting the radio signals, the antenna embedded in the identification means.

8. The real-time ship passenger on-board inventory and passenger safety monitoring system of claim 7, wherein the transceivers are concealed within interior ship designs, fixtures, furniture in selected portions of the ship, wherein the system can identify passenger location within the ship.

9. The real-time ship passenger on-board inventory and passenger safety monitoring system of claim 8, wherein the identification means comprises an electronic room key.

10. The real-time ship passenger on-board inventory and passenger safety monitoring system of claim 8, wherein the identification means comprises an identification device having a wrist band adapted to be worn on the wrist of a passenger.

11. The real-time ship passenger on-board inventory and passenger safety monitoring system of claim 7, wherein the ship is a cruise ship; wherein a number of transceivers are positioned at reception desks in the front office, restaurant entrances, shore excursion and concierge desks, and wherein the transceiver detects the passenger identification means unique identification number as the passenger approaches the transceiver; and wherein display stations are located at said reception desks to identify approaching guests by name as an aid to ship staff in greeting passengers by name and as an aid to capturing on board purchases.

12. A real-time bus passenger on-board inventory and passenger safety monitoring system comprising:
one or more transponders, each transponder secured within an identification means, each identification means assigned to and carried by one passenger, each transponder having a unique identity code wherein each passenger is associated with a unique identify code, the transponder responsive to a received query request transmitted over a radio frequency signal, the transponder adapted to transmit a response radio signal comprising the identity code in response to the received query signal;
one or more of transceivers adapted to transmit a query radio frequency signal to identification means transponders within a limited range, the transceiver adapted to receive responses from a plurality of identification means transponders, the transceivers secured to the bus near passenger access doors;
a passenger onboard inventory database adapted to provide real-time count and inventory of passengers currently onboard; and
one or more display stations in communication with the passenger inventory database, the display stations adapted to display the passenger onboard tally.

13. The real-time bus passenger on-board inventory and passenger safety monitoring system of claim 12, wherein the identification means comprises an identification device having a wrist band adapted to be worn on the wrist of a passenger.

14. The real-time ship passenger on-board inventory and passenger safety monitoring system of claim 8, wherein the identification means comprises an identification card.

15. The real-time bus passenger on-board inventory and passenger safety monitoring system of claim 12, wherein the identification means comprises an identification card.
